(19) United States
(12) Patent Application Publication
(10) Pub. No.: US 2015/0285381 A1
(43) Pub. Date: Oct. 8, 2015

(54) WEDGE SEAL GASKET

(71) Applicants: Christopher B. Preston, Troy, MI (US); Christine A. Blake, Royal Oak, MI (US)

(72) Inventors: Christopher B. Preston, Troy, MI (US); Christine A. Blake, Royal Oak, MI (US)

(73) Assignee: GM GLOBAL TECHNOLOGY OPERATIONS LLC, Detroit, MI (US)

(21) Appl. No.: 14/244,371

(22) Filed: Apr. 3, 2014

(51) Int. Cl. F16J 15/02; F16L 55/00

(52) U.S. Cl. CPC F16J 15/021; F16L 55/00

(57) ABSTRACT

A wedge seal gasket comprising, a carrier, a first wedge seal mounted around the carrier and a second wedge seal mounted around the carrier. The first wedge seal forms a seal with a first housing and the second wedge seal forms a seal with a second housing.

### FIELD

The present disclosure relates to a wedge seal gasket. More particularly, the present disclosure relates to a gasket that forms a wedge seal between two transmission components to seal high pressure hydraulic fluid.

### BACKGROUND

The statements in this section merely provide background information related to the present disclosure and may or may not constitute prior art.

In many transmissions, an O-ring is usually positioned between two mating components to form a seal. Such seals, however, are sensitive to surface finish and clamp load. Accordingly, there is a need for a gasket with improved sealing capabilities.

### SUMMARY

A wedge seal gasket comprising, a carrier, a first wedge seal mounted around the carrier and a second wedge seal mounted around the carrier. The first wedge seal forms a seal with a first housing and the second wedge seal forms a seal with a second housing.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. Moreover, in the figures, like reference numerals designate corresponding parts throughout the views. In the drawings:

FIG. 1 is a perspective view of a wedge seal gasket in accordance with the principles of the present invention; and

FIG. 2 is a cross-sectional view of the gasket mounted between two housings.

### DETAILED DESCRIPTION

The following description is merely exemplary in nature and is not intended to limit the present disclosure, application, or uses.

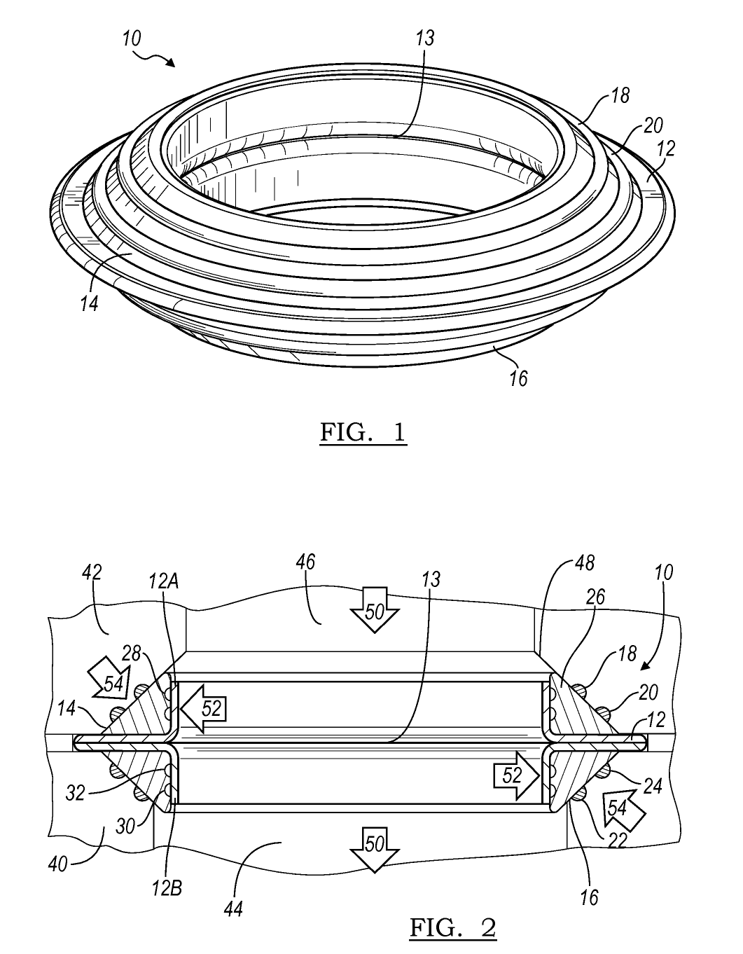

Referring now to the drawings, a wedge seal gasket embodying the principles of the present invention is illustrated in FIGS. 1 and 2 and designated at 10. The wedge seal gasket includes a carrier 12 with an inner bore 13, a first wedge seal 14 and a second wedge seal 16. The carrier 12 can be a single unit or member, or the carrier 12 can include a first member 12a and a second member 12b. The single or two piece members can be formed, for example, stamping, machining or any other suitable process. Further, the two members 12a and 12b can be welded together. Both the first wedge seal 14 and the second wedge seal 16 have a frusto-conical shape and are mounted concentrically around the carrier 12 or the first member 12a and the second member 12b, respectively. The carrier 12 (or the members 12a and 12b) can be made from a metal such as, for example, aluminum or stainless steel. The first wedge seal 14 and the second wedge seal 16 can be made from rubber, silicone, plastic or any other suitable material.

As shown in FIG. 2, the wedge seal gasket 10 is mounted between a housing 42 and a mating housing 40. The wedge seal gasket 10 can include one or more seal beads to enhance the seal between the wedge seal gasket 10 and the housing 42 and the mating housing 40. For example, a pair of spaced apart seal beads 18 and 20 can be mounted concentrically around the first wedge seal 14. The seal beads 18 and 20 further enhance the seal between the first wedge seal 14 and the housing 42. Another pair of spaced apart seal beads 22 and 24 can be mounted concentrically around the second wedge seal 16. The seal beads 22 and 24 further enhance the seal between the second wedge seal 16 and the mating housing 40.

In certain arrangements, the wedge seal gasket 10 includes one or more additional seal beads positioned between the carrier 12 and the wedge seals 14 and 16. For example, a pair of spaced apart seal beads 26 and 28 are mounted concentrically around the carrier 12 (or the first member 12a) between the carrier 12 (or the first member 12a) and the first wedge seal 14 to enhance the seal between the carrier 12 (or the first member 12a) and the first wedge seal 14. A second pair of spaced apart seal beads 30 and 32 can be mounted concentrically around the carrier 12 (or the second member 12b) between the carrier 12 (or the second member 12b) and the second wedge seal 16 to enhance the seal between the carrier 12 (or the second member 12b) and the second wedge seal 16.

The seal beads 18, 20, 22, 24, 26, 28, 30 and 32 can be made from rubber, silicone or any other suitable material.

As further shown in FIG. 2, a chamfer unit 48 forms a seal between the wedge seal gasket 10 and a port 46 associated with the housing 42. Further note, that the wedge shaped seals 14 and 16 facilitate self-centering of the wedge seal gasket 10 with a port 44 associated with the mating housing 40 and the port 46 of the housing 42.

When the wedge seal gasket 10 is in use, high pressure hydraulic fluid flows through the port 46 of the housing 42 to the wedge seal gasket 10 and exits the wedge seal gasket 10 into the port 44 of the mating housing 40 as indicated by the arrows 50. In the meanwhile, the wedge seal gasket 10 provides an axial seal (as indicated by arrows 52) and a seal with radial and axial components (as indicated by arrows 54) between the wedge seal gasket 10 and the housing 42 and the mating housing 40.

In a particular arrangement, the housing 42 is a clutch housing, the mating housing 40 is a concentric slave cylinder (CSC) housing, and the wedge seal gasket is a CSC gasket.

The description of the invention is merely exemplary in nature and variations that do not depart from the gist of the invention are intended to be within the scope of the invention. Such variations are not to be regarded as a departure from the spirit and scope of the invention.

What is claimed is:

1. A wedge seal gasket comprising:
a carrier;
a first wedge seal mounted around the carrier; and
a second wedge seal mounted around the carrier,
wherein the first wedge seal forms a seal with a first housing and the second wedge seal forms a seal with a second housing.

2. The wedge seal gasket of claim 1 wherein the carrier includes a first member and a second member.

3. The wedge seal gasket of claim 2 wherein the first member and the second member are welded together.

4. The wedge seal gasket of claim 1 wherein the first wedge seal and the second wedge seal are made of rubber or silicone.

5. The wedge seal gasket of claim 1 wherein carrier is made of a metal.

6. The wedge seal gasket of claim 1 wherein each of the first wedge seal and the second wedge seal have a frusto-conical shape.

7. The wedge seal gasket of claim 1 further comprising one or more seal beads mounted around first wedge seal.

8. The wedge seal gasket of claim 7 wherein the one or more seal beads are two spaced apart seal beads.

9. The wedge seal gasket of claim 7 further comprising one or more seal beads mounted around the second wedge seal.

10. The wedge seal gasket of claim 9 wherein the one or more seal beads mounted around the second wedge seal are two spaced apart seal beads.

11. The wedge seal gasket of claim 7 wherein the one or more seal beads is made of rubber or silicone.

12. The wedge seal gasket of claim 1 further comprising one or more seal beads mounted around the carrier between the carrier and the first wedge seal.

13. The wedge seal gasket of claim 12 wherein the one or more seal beads are two spaced apart seal beads.

14. The wedge seal gasket of claim 12 further comprising one or more seal beads mounted around the carrier between the carrier and the second wedge seal.

15. The wedge seal gasket of claim 14 wherein the one or more seal beads mounted between the carrier and the second wedge seal are two spaced apart seal beads.

16. The wedge seal gasket of claim 12 wherein the one or more seal beads is made of rubber or silicone.

17. The wedge seal gasket of claim 1 wherein the CSC gasket is self-centering with a port associated with the first housing and another port associated with the second housing.
